(19) United States
(12) Patent Application Publication
(10) Pub. No.: US 2014/0016259 A1
(43) Pub. Date: Jan. 16, 2014

(54) MULTI-MOTHERBOARD POWER DATA COMMUNICATION ARCHITECTURE FOR POWER SUPPLIES

(71) Applicants: Kuang-Lung SHIH, New Taipei City (TW); Tsung-Chun Chen, New Taipei City (TW); Yu-Yuan Chang, New Taipei City (TW)

(72) Inventors: Kuang-Lung SHIH, New Taipei City (TW); Tsung-Chun Chen, New Taipei City (TW); Yu-Yuan Chang, New Taipei City (TW)

(21) Appl. No.: 13/546,485

(22) Filed: Jul. 11, 2012

(51) Int. Cl. G06F 1/16

(52) U.S. Cl. 361/679.31

(57) ABSTRACT

A multi-motherboard power data communication architecture for power supplies located in an electronic apparatus includes at least a power supply unit, a data communication control unit, a first motherboard and a second motherboard. The power supply unit includes a power source management unit to generate at least one corresponding working parameter based on operating states of the power supply unit. The data communication control unit includes at least one power source management connection port to get the working parameter of the power supply unit, a buffer memory unit to store the working parameter, and a first data output port and a second data output port to respectively output the working parameter. The first motherboard and second motherboard are electrically connected to the first and second data output ports respectively to read the working parameter saved in the buffer memory unit.

### FIELD OF THE INVENTION

The present invention relates to power data communication architecture and particularly to power data communication architecture adapted to an electronic apparatus equipped with power supply units and multiple motherboards.

### BACKGROUND OF THE INVENTION

Advance of computer technology has enabled computer systems to provide a wide variety of functions in response to users' requirements, such as data processing or recreational activities. They need to continuously process a huge amount of complex information, and require stable and great amount of power supply. To prevent abrupt power outage or surge caused by switching to backup power that might damage expensive and complex electronic apparatus and result in instant loss of processing information, advanced computer systems generally adopt N+M redundant power supply system to maintain normal operation without interrupting power supply. N represents the number of combined power supplies required to support the total power load value of the electronic apparatus, while M indicates the allowable number of dysfunctional power supplies. N≧1, and M≧1. A redundant power supply system includes N+M sets of power supplies. Each power supply includes a standby power unit to provide standby DC power and a main power unit to output DC power in a power on state. At present many types of redundant power supply systems have been developed to enhance backup or fault tolerance function. For instance, U.S. Pat. No. 7,394,674 provides a backup power supply with parallel AC power source and DC power source. It adopts a dual-power source input design to continuously supply DC power to electronic apparatus to maintain normal operation thereof when outage of any one power input source occurs.

Although adequate power can be provided by using the aforesaid N+M redundant power supply system in order to meet the requirement of increasing performances of computer system, a great amount of power sources is simultaneously consumed. Thus, the importance of power source management system has gained growing awareness, especially under the prevailing trend of green and eco-friendly technology. At present the most commonly adopted power source management systems include the Advanced Power Management (APM) and the Advanced Configuration and Power Interface (ACPI). The conventional APM is predominantly controlled by a firmware based on Basic Input/Output System (BIOS), under which the input of commands or decisions is difficult. Furthermore, the power cannot be adjusted effectively with changes of the operation system. The ACPI is a new power source management technique. Users can perform power source management through the operation system and can inspect power source consumption status. As the ACPI employs the operation system that extensively controls hardware to replace the conventional power source management through the BIOS, the power source management efficiency can be effectively improved. Moreover, power source management of the ACPI can be incorporated with hardware to register and control the power loss status of many apparatus. The items being monitored are extensive, including the voltage of power supply, the temperature of motherboard and the rotational speed of air fans etc.

However, in the architecture of the N+M redundant power supply system, if the motherboard is required to perform power source management among different power supplies, in order to obtain monitored power information from different power supplies, the firmware of the motherboard must be modified, or more electric contacts connected to a plurality of power supplies have to be provided to identify the power supplies. But such approaches cannot be simply adapted to the motherboard whose architecture has been finished already.

### SUMMARY OF THE INVENTION

The primary object of the present invention is to solve the problem of the conventional motherboard used on an N+M redundant power supply system that has to change firmware or hardware. To achieve the foregoing object, the present invention provides multi-motherboard power data communication architecture for power supplies located in an electronic apparatus. It includes at least one power supply unit to provide operation power for the electronic apparatus, a data communication control unit and a first motherboard and a second motherboard. The power supply unit includes a power source management unit to generate at least one corresponding working parameter based on operating states of the power supply unit. The data communication control unit includes at least one power source management connection port to get the working parameter from the power supply unit, a buffer memory unit to store the working parameter, and a first data output port and a second data output port electrically connected to the buffer memory unit to respectively output the working parameter. The first motherboard and second motherboard are electrically connected to the first data output port and the second data output port respectively to read the working parameter saved in the buffer memory unit.

In one embodiment the first motherboard includes a first serial data line and a first serial clock line connected to the first data output port of the data communication control unit.

In another embodiment the second motherboard includes a second serial data line and a second serial clock line connected to the second data output port of the data communication control unit.

In yet another embodiment the data communication control unit includes a third serial data line and a third serial clock line connected to the power source management unit.

In yet another embodiment the working parameter is the voltage value of the operation power.

In yet another embodiment the power source management unit is electrically connected to a temperature detection unit, and the working parameter is the interior temperature of the power supply unit.

In yet another embodiment the power source management unit is electrically connected to a cooling fan, and the working parameter is the rotational speed of the cooling fan.

In yet another embodiment the power supply unit includes a rectification filter unit connected to an external power source, a power factor correction unit connected to the rectification filter unit, a transformer, a pulse width control unit, a switch element and a rectification output unit.

In yet another embodiment the power supply unit is electrically connected to an external power source to convert and output the operation power to drive the electronic apparatus for operation.

In yet another embodiment the data communication control unit includes a micro-control unit electrically connected to the power source management connection port.

In yet another embodiment the multi-motherboard power data communication architecture includes a first power supply unit and a second power supply unit. The first power supply unit has a first power source management unit to generate at least one first working parameter based on operating states of the first power supply unit. The second power supply unit has a second power source management unit to generate at least one second working parameter based on operating states of the second power supply unit.

In yet another embodiment the multi-motherboard power data communication architecture includes a first power source management connection port connected to the first power source management unit and a second power source management connection port connected to the second power source management unit.

In short, in the multi-motherboard power data communication architecture of the invention, a data communication control unit is provided and interposed between the power supply units and the motherboards. The data communication control unit can get and store the working parameters from different power supply units, and allow the motherboards at the rear end to read. Thus there is no need to change the software or firmware of the motherboards in response to different number of power supply units, and the motherboards can be used in an N+M redundant power supply system.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of an embodiment of the multi-motherboard power data communication architecture of the invention.

### DETAILED DESCRIPTION OF THE PREFERRED EMBODIMENTS

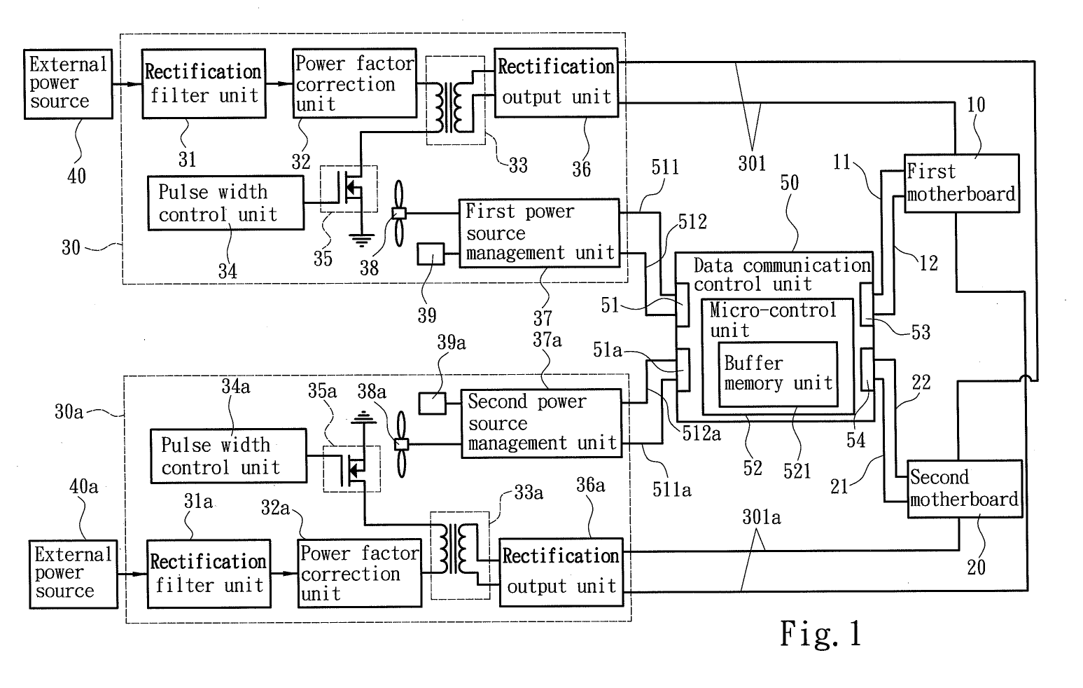

Please refer to FIG. 1 for the circuit block diagram of an embodiment of the multi-motherboard power data communication architecture of the invention. It is located in an electronic apparatus which is a computer system in this embodiment. The computer system includes a first motherboard 10 and a second motherboard 20 capable of parallel computing, and a first power supply unit 30 and a second power supply unit 30a that are coupled in parallel and independently output an operation power. The first and second motherboards 10 and 20 have respectively at least a central processing unit (CPU) and other electronic elements and circuits. The first power supply unit 30 includes N sets and the second power supply unit 30a includes M sets that can be integrated to form an N+M redundant power supply system, wherein N≧1 and M≧1. In this embodiment, N=1 and M=1. The first and second power supply units 30 and 30a include respectively a rectification filter unit 31 and 31a connected to an external power source 40 and 40a, a power factor correction unit 32 and 32a connected to the rectification filter unit 31 and 31a, a transformer 33 and 33a, a pulse width control unit 34 and 34a, a switch element 35 and 35a, and a rectification output unit 36 and 36a. The external power sources 40 and 40a output external AC power which passes through the rectification filter units 31 and 31a and power factor correction units 32 and 32a. The power factor correction units 32 and 32a regulate the power factor and voltage of the external power through a voltage transformation power level. The pulse width control unit 34 and 34a determine the duty cycle of the switch elements 35 and 35a, thereby regulate the coil current passing through the transformers 33 and 33a. Finally, the rectification output units 36 and 36a generate respectively an operation power 301 and 301a and transmit the operation power 301 and 301a to the first motherboard 10 and the second motherboard 20. Moreover, the first and second power supply units 30 and 30a can be electrically connected to at least one power integration control unit (not shown in the drawings) simultaneously. The first and second power supply units 30 and 30a also contain respectively at least one cooling fan 38 and 38a and one temperature detection unit 39 and 39a. The cooling fans 38 and 38a and the temperature detection units 39 and 39a are further electrically connected to the first and second power source management units 37 and 37a respectively.

The first power supply unit 30 includes a first power source management unit 37 which generates at least one corresponding first working parameter based on operating states of the first power supply unit 30. The second power supply unit 30a includes a second power source management unit 37a which generates at least one corresponding second working parameter based on operating states of the second power supply unit 30a. The first and second working parameters can be voltage values of the operation power 301 and 301a, the interior temperature of the first and second power supply units 30 and 30a, or the rotational speeds of the cooling fans 38 and 38a.

The computer system further includes a data communication control unit 50 that is electrically connected to the first and second power supply units 30 and 30a, and the first and second motherboards 10 and 20. The data communication control unit 50 includes a first power source management connection port 51 connected to the first power source management unit 37 and a second power source management connection port 51a connected to the second power source management unit 37a, and a micro-control unit 52 to get the first and second working parameters through the first and second power source management connection ports 51 and 51a. The micro-control unit 52 includes a buffer memory unit 521 to store the first and second working parameters. In addition, the data communication control unit 50 includes a first data output port 53 and a second data output port 54 that are electrically connected to the buffer memory unit 521 to output the first and second working parameters respectively. The first motherboard 10 and second motherboard 20 are electrically connected to the first data output port 53 and the second data output port 54 respectively to read the first working parameter or second working parameter saved in the buffer memory unit 521. When the first motherboard 10 or the second motherboard 20 intends to monitor or manage the first power supply unit 30 or the second power supply unit 30a, it selects and reads the first or second working parameter saved in the buffer memory unit 521 through software, then the CPU on the first motherboard 10 or the second motherboard 20 performs power source management to the first power supply unit 30 or second power supply unit 30a. In this embodiment, the data communication control unit 50 is connected to the first and second power supply units 30 and 30a, and the first and second motherboards 10 and 20 via an internal integrated circuit (Inter-Integrated Circuit, I²C) bus. The first and second power source management connection ports 51 and 51a of the data communication control unit 50 include respectively third serial data lines 511 and 511a and third serial clock lines 512 and 512a that are connected respectively to the first and second power source management units 37 and 37a. The first motherboard 10 includes a first serial data line 11 and a first serial clock line 12 connected to the first data output port 53 of the data communication control unit 50. The second motherboard 20 includes a second serial data line 21 and a second serial clock line 22 connected to the second data output port 54 of the data communication control unit 50. The first serial data line 11, the second serial data line 21 and the third serial data lines 511 and 511a transmit data and address in a two-way fashion. The first serial clock line 12, second serial clock line 22 and third serial clock lines 512 and 512a transmit clock in a two-way fashion.

The multi-motherboard power data communication architecture of the invention, through the data communication control unit interposed between the motherboards and power supply units, can save in advance a plurality of working parameters of the power supply units, and then different motherboards can receive the working parameters of different power supply units through corresponding data output ports to perform power source management. Hence no change of firmware or adding of electric contacts on the motherboards is needed in response to different number of power supply units. The architecture of the electronic apparatus including multiple power supply units and motherboards thus formed can be widely used in various applications.

While the preferred embodiments of the invention have been set forth for the purpose of disclosure, they are not the limitations of the invention. Modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A multi-motherboard power data communication architecture for power supplies located in an electronic apparatus, comprising:
at least one power supply unit which provides an operation power for the electronic apparatus and includes a power source management unit to generate at least one corresponding working parameter based on operating states of the at least one power supply unit;
a data communication control unit including at least one power source management connection port to get the at least one working parameter from the at least one power supply unit, a buffer memory unit to store the at least one working parameter, and a first data output port and a second data output port that are electrically connected to the buffer memory unit to respectively output the at least one working parameter; and
a first motherboard and a second motherboard that are electrically connected to the first data output port and the second data output port respectively to read the at least one working parameter saved in the buffer memory unit.

2. The multi-motherboard power data communication architecture of claim 1, wherein the first motherboard includes a first serial data line and a first serial clock line connected to the first data output port of the data communication control unit.

3. The multi-motherboard power data communication architecture of claim 1, wherein the second motherboard includes a second serial data line and a second serial clock line connected to the second data output port of the data communication control unit.

4. The multi-motherboard power data communication architecture of claim 1, wherein the data communication control unit includes at least one third serial data line and at least one third serial clock line connected to the power source management unit.

5. The multi-motherboard power data communication architecture of claim 1, wherein the working parameter is a voltage value of the operation power.

6. The multi-motherboard power data communication architecture of claim 1, wherein the power source management unit is electrically connected to a temperature detection unit, the working parameter being an interior temperature of the at least one power supply unit.

7. The multi-motherboard power data communication architecture of claim 1, wherein the power source management unit is electrically connected to a cooling fan, the working parameter being a rotational speed of the cooling fan.

8. The multi-motherboard power data communication architecture of claim 1, wherein the at least one power supply unit includes a rectification filter unit connected to an external power source, a power factor correction unit connected to the rectification filter unit, a transformer, a pulse width control unit, a switch element and a rectification output unit.

9. The multi-motherboard power data communication architecture of claim 1, wherein the at least one power supply unit is electrically connected to an external power source to convert and output the operation power to drive the electronic apparatus for operation.

10. The multi-motherboard power data communication architecture of claim 1, wherein the data communication control unit includes a micro-control unit electrically connected to the at least one power source management connection port.

11. The multi-motherboard power data communication architecture of claim 1 including a first power supply unit and a second power supply unit, the first power supply unit including a first power source management unit to generate at least one corresponding first working parameter based on operating states of the first power supply unit, the second power supply unit including a second power source management unit to generate at least one corresponding second working parameter based on operating states of the second power supply unit.

12. The multi-motherboard power data communication architecture of claim 11, wherein the data communication control unit includes a first power source management connection port connecting to the first power source management unit and a second power source management connection port connecting to the second power source management unit.
